(19) United States
(12) Patent Application Publication
(10) Pub. No.: US 2023/0376769 A1
(43) Pub. Date: Nov. 23, 2023

(54) METHOD AND SYSTEM FOR TRAINING MACHINE LEARNING MODELS USING DYNAMIC FIXED-POINT DATA REPRESENTATIONS

(71) Applicants: Seyed Alireza GHAFFARI, Montreal (CA); Eyyüb HACHMIE SARI, Montreal (CA); Vahid PARTOVI NIA, Montreal (CA)

(72) Inventors: Seyed Alireza GHAFFARI, Montreal (CA); Eyyüb HACHMIE SARI, Montreal (CA); Vahid PARTOVI NIA, Montreal (CA)

(21) Appl. No.: 17/747,579

(22) Filed: May 18, 2022

(51) Int. Cl. G06N 3/08; G06F 7/499

(52) U.S. Cl. CPC G06N 3/084; G06F 7/49957

(57) ABSTRACT

Systems and methods for training a machine learning model. The methods comprise receiving a plurality of first data points, each data point of the first data points being represented in a floating-point representation. The methods further comprise converting the plurality of first data points into a corresponding plurality of second data points. Each of the second data points is represented in a dynamic fixed-point representation. The plurality of second data points may include: for each second data point, the sign component of the corresponding first data point, for each second data point, a dynamic fixed-point mantissa component, and one or more shared fraction components. At least two of the second data points share a value of a shared fraction component of the one or more shared fraction components. The methods further comprise performing integer computations during training of the machine learning model using the second data points.

### RELATED APPLICATIONS

This is the first application filed for the present disclosure.

### TECHNICAL FIELD

The present disclosure relates to machine learning model training and inference making, and particularly, methods and systems for training and inference making of machine learning models using dynamic fixed-point data representation.

### BACKGROUND

Deep learning models are made up of a number of layers that each include a plurality of computational units, with connections among computational units of different layers. Each layer in a deep learning model process data by performing a series of computations. The computations performed by each layer may include a dot product computation that involves multiplying a set of input values by a respective set of weights and summing the products, then adjusting the resulting number by a bias of the respective layer. Some deep learning models also apply a nonlinear activation function to the adjusted number to generate an output. The activation function ensures an output value passed on to a subsequent layer is within a tunable, expected range. This series of computations are repeated by the respective layers until a final output layer of the deep learning model generates scores or predictions related to a particular task. Deep learning models can perform inference tasks, such as object detection, image classification, clustering, voice recognition, or pattern recognition. Deep learning models typically do not need to be programmed with task-specific rules. Instead, deep learning models generally perform supervised learning during training to build knowledge from datasets where the correct answer is provided in advance. A deep learning model learns by iteratively tuning the weights and biases applied to its layers until the model can find the correct answer.

Deep learning models are commonly trained based on data having floating-point representation, also referred to as floating-point deep learning models. The floating-point deep learning models have layers of computational units operating on values represented using floating-point, referred to as floating-point neurons. Layers of floating-point deep learning models perform computations, such as multiplication, addition, and normalization. Deep learning models' computations are performed using tensors. Each element of each tensor is a real number. As used in this disclosure, a tensor can refer to an ordered data structure of elements in which the location of an element in the data structure has meaning. Examples of a tensor are a vector such as a row vector or column vector, a two-dimensional matrix with multiple rows and columns of elements, a three-dimensional matrix, etc. In the case of a floating-point layer, the set of input values to the full-point layer is typically arranged as elements of a feature vector. The set of weights applied by the full-point computational unit is arranged as elements of a weight vector.

In a floating-point layer, each element of each vector usually requires more than 8 bits to represent the values (e.g., the individual elements in an input feature vector are each real values expressed generally using more than 8 bits, and the parameters of the floating-point computational unit, such as weights included in a weight vector, are also real values represented using more than 8 bits). Because each value in each vector is represented in a floating-point representation, the deep learning model computations are performed by floating-point layers that are computationally intensive. Using numbers in floating-point representation places constraints on the use of floating-point deep learning models in computationally constrained hardware devices.

Accordingly, there is a growing interest in methods and systems that may reduce the number of computations required when training a deep learning model configured for a particular task and enable the model to be trained in computationally constrained hardware devices. For example, computationally constrained hardware devices may employ less powerful processing units, less powerful (or no) accelerators, less memory and/or consume less power than more powerful hardware devices typically required for training deep learning models.

Accordingly, there is a need for systems and methods that reduce or eliminate the number of computations required to generate a deep learning model via training capable of providing acceptable accuracy.

### SUMMARY

The present disclosure provides methods and systems for training a machine learning model that performs computations, partly or fully, using integer computations rather than floating number operations. To perform such integer computations, the machine learning model uses and processes data having a dynamic fixed-point representation. Accordingly, the machine learning model that process data with dynamic fixed-point representation rather than floating-point representation is more efficient for both training and inference making phases. The machine learning model as referred to herein could be any type of models e.g. a simple neural network, or deep learning models e.g. a deep neural network, transformers, or a combination thereof.

More particularly, some embodiments describe converting data represented in a floating-point representation into data represented in a dynamic fixed-point representation. The data in dynamic fixed-point representation may then be used to generate a machine learning model. The data in dynamic fixed-point representation may be used in both forward propagation and backpropagation to generate the machine learning model. In addition, some embodiments describe the conversion of the data to include quantizing the data that is represented in a floating-point representation to generate data in a dynamic fixed-point representation, and processing the data in a dynamic fixed-point representation using integer computations. Some embodiments may further de-quantize the data in a dynamic fixed-point representation back to data in a floating-point representation through a de-quantization operation.

In one aspect, some embodiments describe a computer-implemented method for training a machine learning model. The method may include receiving a plurality of first data points, each data point of the first data points being represented in a floating-point representation. The floating-point representation comprises a sign component represented as an integer, a floating-point exponent component represented as an integer, and a floating-point mantissa component represented as an integer. Further, the method includes converting the plurality of first data points into a corresponding plurality of second data points. Each of the second data points is represented in a dynamic fixed-point representation. Each second data point may have the sign component of the corresponding first data point. Further, each second data point may have a dynamic fixed-point mantissa component. Also at least two of the second data points share a value of a shared fraction component of one or more shared fraction components. The method may further include performing integer computations during training of the machine learning model using the second data points.

In example embodiments of the above method, converting the first data points into second data points comprises generating preliminary second data points by adjusting the value of the floating-point mantissa component of each data point of the first data point. The adjustment is based on a value of the shared fraction component. Each data point of the preliminary second data points has the sign component and a preliminary mantissa component, and at least two of the preliminary second data points share the value of the shared fraction component.

In example embodiments of the above methods, each data point of the second data points is generated by rounding a value of the preliminary mantissa component of each data point of the preliminary second data points. The rounding is to conform with a desired number of bits for representing a value of the dynamic fixed-point mantissa component of the second data points. In example embodiments, the rounding is stochastic rounding. In example embodiments, the floating-point representation is based on the IEEE754 standard or a custom floating-point representation.

In example embodiments of the above methods, the training comprises inputting the second data points into a machine learning model to forward propagate the second data points through the machine learning model and generate predictions for the second data points. Further, the training comprises computing a loss based on the predictions and ground-truth labels of the second data points using integer computations. Also, the training comprises back-propagating the loss (or total loss) through the machine learning model to adjust values of parameters of the machine learning model using integer computations.

In example embodiments of the above methods, the back-propagating comprises computing gradients, the gradients being computed using integer computations. In example embodiments, the forward propagate comprises performing integer computations at a plurality of layers of the machine learning model.

In example embodiments, the plurality of layers includes integer layers performing integer computations and floating-point layers performing floating-point computations.

In example embodiments, the backpropagation uses an optimization method to adjust the values of the learnable parameters. In example embodiments, the optimization method is stochastic gradient descent. In example embodiments, computations of the optimization method are performed using integer computations. In example embodiments, the machine learning model is a deep learning model.

In another aspect, some embodiments describe a system for training a machine learning model. The system comprises a processor; and a memory storing instructions which, when executed by the processor, cause the system to receive a plurality of first data points. Each data point of the first data points is represented in a floating-point representation comprising: a sign component represented as an integer, a floating-point exponent component represented as an integer, and a floating-point mantissa component represented as an integer. The memory stores further instructions, when executed by the processor, cause the system to convert the plurality of first data points into a corresponding plurality of second data points. Each of the second data points is represented in a dynamic fixed-point representation. The plurality of second data points comprises: for each second data point, the sign component of the corresponding first data point; for each second data point, a dynamic fixed-point mantissa component, and one or more shared fraction components. At least two of the second data points share a value of a shared fraction component of the one or more shared fraction components. The memory stores further instructions, when executed by the processor, cause the system to perform integer computations during training of the machine learning model using the second data points.

In example embodiments of the above system, converting the first data points into second data points comprises generating preliminary second data points by adjusting the value of the floating-point mantissa component of each data point of the first data point. The adjustment is based on a value of the shared fraction component. Each data point of the preliminary second data points has the sign component and a preliminary mantissa component, and at least two of the preliminary second data points share the value of the shared fraction component.

In example embodiments of the above systems, each data point of the second data points is generated by rounding a value of the preliminary mantissa component of each data point of the preliminary second data points. The rounding is to conform with a desired number of bits for representing a value of the dynamic fixed-point mantissa component of the second data points. In example embodiments, the rounding is stochastic rounding. In example embodiments, the floating-point representation is based on the IEEE754 standard or a custom floating-point representation.

In example embodiments of the above systems, the training comprises inputting the second data points into a machine learning model to forward propagate the second data points through the machine learning model and generate predictions for the second data points. Further, the training comprises computing a loss based on the predictions and ground-truth labels of the second data points using integer computations. Also, the training comprises back-propagating the total loss through the machine learning model to adjust values of parameters of the machine learning model using integer computations.

In example embodiments of the above systems, the back-propagating comprises computing gradients, the gradients being computed using integer computations. In example embodiments, the forward propagate comprises performing integer computations at a plurality of layers of the machine learning model.

In example embodiments, the plurality of layers includes integer layers performing integer computations and floating-point layers performing floating-point computations.

In example embodiments, the backpropagation uses an optimization method to adjust the values of the parameters (or learnable parameters). In example embodiments, the optimization method is stochastic gradient descent. In example embodiments, computations of the optimization method are performed using integer computations. In example embodiments, the machine learning model is a deep learning model.

In yet another aspect, some embodiments describe a computer-readable medium having tangibly stored thereon computer-executable instructions that, in response to execution by a processor of a compiler system, cause the system for training a machine learning model to perform any one of methods above.

### BRIEF DESCRIPTION OF THE DRAWINGS

FIG. 1 is an illustrative example of one floating-point representation described in the IEEE754 standard commonly used in computing devices, in accordance with example embodiments.

FIG. 2 is an illustrative example of floating-point numbers, each represented as a set of integers, and respective numbers in dynamic fixed-point representation, in accordance with example embodiments.

FIG. 3 is a block diagram of a quantization module used to convert floating-point numbers into dynamic fixed-point numbers, in accordance with example embodiments.

FIG. 4 is an algorithm illustrating the process performed by the quantization module of FIG. 3, in accordance with example embodiments.

FIG. 5 is an example deep learning model performing operations using data having dynamic fixed-point representation, in accordance with example embodiments.

FIG. 6 is a dataflow diagram illustrating operations in the integer intermediate layer of a deep learning model of FIG. 5, in accordance with example embodiments.

FIG. 7 is a dataflow diagram illustrating processes performed in the de-quantization module, in accordance with example embodiments.

FIG. 8 is a schematic diagram of another deep learning model illustrating the training process in accordance with example embodiments.

FIG. 9 is a flowchart of a training method of a machine learning model, in accordance with example embodiments.

FIG. 10 is a flowchart of a conversion method that converts floating-point numbers into a dynamic fixed-point number, in accordance with example embodiments.

FIG. 11 is a flowchart of an inference-making method, in accordance with example embodiments.

FIG. 12 illustrates an example computing device that can be employed to implement the methods and systems disclosed herein, in accordance with an example embodiment.

Similar reference numerals may have been used in different figures to denote similar components.

### DETAILED DESCRIPTION OF THE EXAMPLE EMBODIMENTS

As an overview, data that may be used in the methods and systems described herein are digital data represented by numbers. These numbers can be real numbers represented in a floating-point representation. Numbers in floating-point representation is conventionally used and processed in machine learning models. Some embodiments of the present disclosure describe using numbers in a dynamic fixed-point representation instead of a floating-point representation. With the dynamic fixed-point representation, integer computations can be performed instead of floating-point operations. These integer computations are much faster than floating-point operations and require fewer resources. Accordingly, machine learning models that can leverage processing data using dynamic fixed-point representation may be more efficient and faster than machine learning models that process data with floating-point representation.

In one embodiment, described are methods and systems for dynamic fixed-point training of a machine learning model where at least some data (e.g. numbers and also referred to as operands) are in dynamic fixed-point representation instead of floating-point representation. Accordingly, operations performed on the data in dynamic fixed-point representation may be performed as efficient integer computations. In another embodiment, the described methods and systems that generate the model using dynamic fixed-point representations can use such models for inference (or inference making). In other words, the computation (or operations) performed during inference may also leverage a dynamic fixed-point representation to perform efficient integer computations.

As described, example embodiments may generate and use machine learning models using data in a dynamic fixed-point representation. Dynamic fixed-point representation represents real numbers (e.g. data) in a representation that includes a set of integer numbers having a shared fraction component, a plurality of sign components, and a plurality of dynamic fixed-point mantissa components. In other words, the shared fraction component, the plurality of sign components, and the plurality of dynamic fixed-point mantissa components may have integer values. The shared fraction component has a value shared among a plurality of data being processed (e.g., in a tensor). In other words, a subset of the processed data (e.g., two or more input data of the processed data) may share the same shared fraction component.

Example embodiments describe converting the data (e.g. real numbers) from floating-point representation to dynamic fixed-point representation. In general, the conversion to dynamic fixed-point representation includes retaining the value of the sign component of the floating-point representation as the sign component of the dynamic fixed-point representation. The value of the dynamic fixed-point mantissa component for the dynamic fixed-point representation may be a shifted and rounded version of the value of the floating-point mantissa component of the floating-point representation. Unlike the floating-point representation where each real number has a respective floating-point exponent component, in dynamic fixed-point point representation, the real numbers of the data (e.g. within a tensor, or other data format) may share the same fraction component. It should be noted that all real numbers, or a subset of the real numbers of the data may share the same fraction component. For example, all data processed within a given training iteration may share the same fraction component, or a subset of data within the training iteration may share the same fraction component.

As referred to earlier, computations performed by a machine learning model are conventionally based on one or more floating-point representations (also interchangeably referred to as formats). For example, one type of floating-point format is the IEEE754 standard as further described in IEEE Computer Society. “IEEE Standard for Floating-Point Arithmetic.” IEEE Std 754-2008 (2008): 1-70, which is incorporated herein in its entirety by reference. The floating-point formats of the IEEE754 standard usually represent a floating-point number with high-precision using, for example, 32 bits.

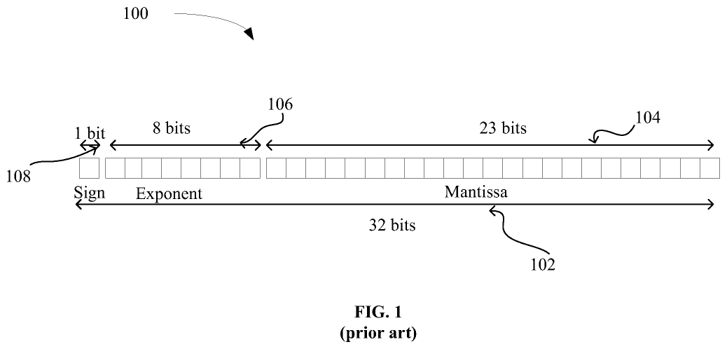

FIG. 1 is an illustrative example of a format of the IEEE754 standard for a floating-point representation (or format) 100 commonly used to represent floating-point numbers 102 (e.g. real numbers represented using floating-point formats). This example illustrates the single-precision floating-point representation of the IEEE754 standard. This example is only one of the representations described in the IEEE754 standard. In computing devices, internally, the single-precision floating-point representation includes 1 bit reserved for the value of the sign component of a floating-point number 102, 8 bits reserved for the value of the floating-point exponent component 106 of the floating-point number 102, and 23 bits reserved for the value of the floating-point mantissa component 104 of the floating-point number 102. Therefore, a floating-point number can be represented by a set of integers comprising a sign component, a floating-point exponent component, and a floating-point mantissa component.

Furthermore, there is an exponent bias, which is a number considered in the arithmetic calculations by the processor when performing operations on data having floating-point representation. As a result, a floating-point number having the floating-point representation of FIG. 1 may include three binary strings, which are the sign component 108, floating-point exponent component 106, and floating-point mantissa component 104.

As known in the art, a string of binary numbers (base-2) can be represented as a decimal number (e.g. base 10). While computing devices usually store numbers using binary numbers, these numbers are typically displayed to humans as decimal numbers. Hence, each binary number (value of sign component 108, value of floating-point exponent component 106, and value of floating-point mantissa component 104) can be represented as a decimal number. Therefore, a floating-point number can be represented by a set of three integers, wherein each integer may be in binary or decimal. A person skilled in the art understands the difference between integer numbers (interchangeably referred to as integers) and real numbers.

Consequently, a computing device can receive a real number as input (e.g. entered by a user or received from a storage medium). The real number can be represented as a floating-point number represented by a set of integers (floating-point representation) according to the IEEE754 standard. Therefore, while the set of integers is how the real number is internally represented in the computing device, a user sees and perhaps enters real numbers (e.g. 1.984) instead of the three components (e.g. the set of integers). Similarly, the data as real numbers are passed to the computing device for processing, such as from a data set.

In summary, it follows that data has numbers, and the numbers are usually real numbers. From the discussion above, the real numbers are represented as floating point number with floating-point representation (e.g. one representation of the IEEE754 standard). According to the IEEE754, the floating-point numbers are represented by three integers. Different numeral systems may be used to represent any number, for example, base-2 numeral system (binary), base-10 numeral system (decimal), etc. Generally, the base-2 numeral system is how computing devices store data and the base-10 numeral system is how such computing devices display (and often) receive data.

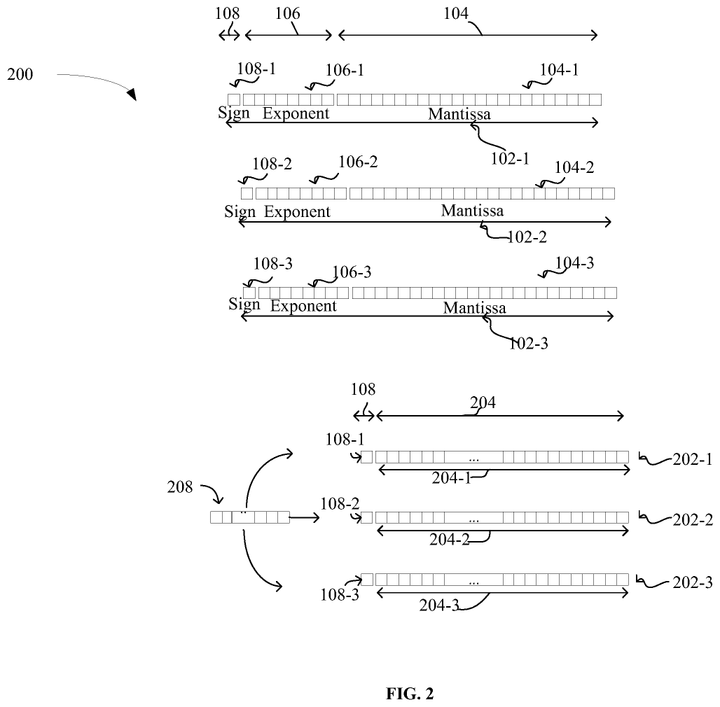

As described, conventionally, floating-point deep learning models may perform computations on operands using the floating-point representation. However, the high-precision of IEEE754 formats may not be always required, and instead, lower precision may be adequate to improve processing efficiency. In order to improve such processing efficiency, described in some embodiments is a specialized conversion process to convert floating-point representation into dynamic fixed-point representation as further described with reference to FIG. 2.

FIG. 2 is an example embodiment illustrating a schematic diagram 200 for number conversion from floating-point representation into dynamic fixed-point representation using a quantization method. FIG. 2 shows three floating-point numbers 102-1, 102-2, and 102-3 each consisting of three integers forming a floating-point representation. The quantization method converts the floating-point numbers 102-1, 102-2, and 102-3 to numbers having dynamic fixed-point representation. This dynamic fixed-point representation is “dynamic” because the representation changes based on the pool of floating-point numbers converted (e.g. the numbers in the tensor).

The floating-point number 102-1 is converted to a respective dynamic fixed-point number 202-1, the floating-point number 102-2 is converted to a respective dynamic fixed-point number 202-2, and the floating-point number 102-3 is converted to a respective dynamic fixed-point number 202-3. Each of the dynamic fixed-point numbers (202-1, 202-2, 202-3) has two components distinct to a given dynamic fixed-point number—a sign component 108 (individually labelled 108-1, 108-2, 108-3) and a dynamic fixed-point mantissa component 204 (individually labelled 204-1, 204-2, 204-3), and one component that may be shared with one or more other dynamic fixed-point numbers (202-1, 202-2, 202-3), namely a shared fraction component 208. In other words, the shared fraction component 208 has a value common to all, or several, of the dynamic fixed-point numbers 202-1, 202-2, 202-3.

In different embodiments, the number of bits representing the shared fraction component 208 and/or the dynamic fixed-point mantissa component 204 may be customized or varied. For instance, the shared fraction component 208 may be represented with 8 bits, the sign component (108-1, 108-2, 108-3) may be represented with 1 bit, and the dynamic fixed-point mantissa component 204 of dynamic fixed-point numbers 202-1, 202-2, and 202-3 may be represented with 7 bits. This results in a signed number of 8 bits (i.e., 7+1), which also shares an 8-bit shared fraction component 208 with one or more other numbers. In some examples, the resulting number is considered to be effectively 8 bits in length because a single shared fraction component 208 may be shared by many such dynamic fixed-point numbers, e.g. hundreds or thousands of dynamic fixed-point numbers. It is understood by a person skilled in the art that various number of bits may be used. All example embodiments herein discuss the sign component (108) having a single bit, which is typically used; however, a person skilled in the art will understand that the methods described herein are equally applicable if the sign component has a custom number of bits.

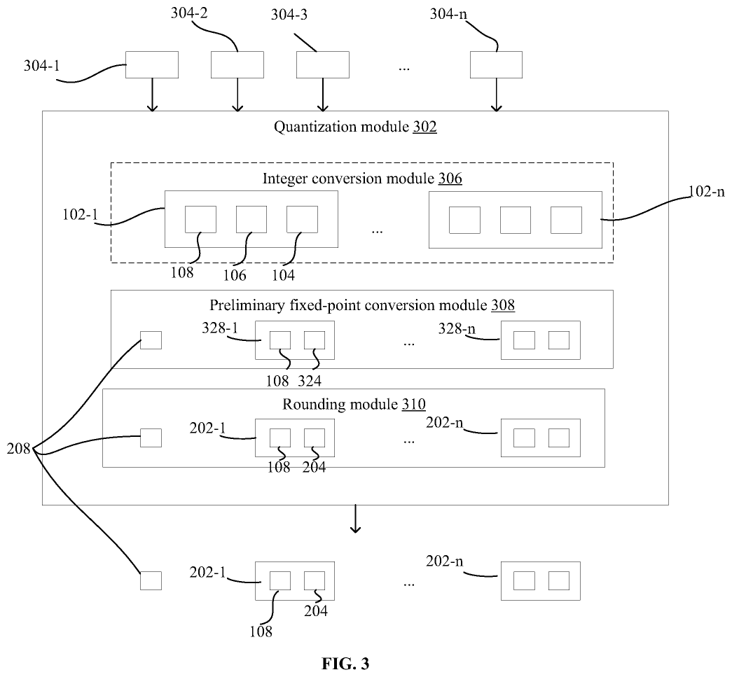

FIG. 3 is a schematic diagram for a quantization method according to example embodiments. The quantization method may be implemented by a quantization module (or manager, component, etc.) 302, which may receive input as a plurality of real numbers (304-1, 304-2, 304-3, . . . , 304-n). Therefore, the real numbers (304-1, . . . , 304-n) can be the input, which could be data received from a user through a user interface or data stored on a storage device such as a dataset. These real numbers, when stored on a computing device, may be stored as floating-point numbers 102-1, . . . , 102-n having a floating point representation. The conversion from real number 304-1, . . . , 304-n to floating-point numbers 102-1, . . . , 102-n can be performed implicitly by computing devices or explicitly using the integer conversion module 306. Dashed blocks represent optional blocks. The real numbers (304-1, . . . , 304-n) may be combined in a tensor format or any combination such that the quantization module 302 can extract a plurality of floating-point numbers by the integer conversion module 306. The quantization module 302 may include a plurality of modules to convert the data samples (304-1, . . . , 304-n) into a plurality of dynamic fixed-point numbers (202-1, . . . , 202-n). In this example embodiment, all of the dynamic fixed-point numbers (202-1, . . . , , 202-n) share a single fraction component 208, and each has a respective sign component 108 and dynamic fixed-point mantissa component 204. In other example embodiments, for example, there are multiple fraction components 208, each of which is shared only by a subset of the dynamic fixed-point numbers (202-1, . . . , 202-n). For instance, a first subset (202-1, . . . , 202-i), i≤n, of the dynamic fixed-point numbers (202-1, . . . , 202-n) may correspond to data generated by a training iteration of a machine learning model or data of a training epoch, and all numbers of the first subset may share a common fraction component 208.

The quantization module 302 receives the input as real numbers (304-1, . . . , 304-n) and a conversion of each input as real number (304-1, . . . , 304-n) is performed by an integer conversion module (or manager, component, etc.) 306 to generate a floating-point number (102-1, . . . , 102-n). Each floating-point number represented as a floating-point representation comprising a set of integers having a sign component 108, a floating-point exponent component 106, and a floating-point mantissa component 104. The values of the sign component 108, floating-point exponent component 106, and floating-point mantissa component 104 can be represented as integer values. It is understood by a person skilled in the art that the integer conversion module 306 is an optional module, because computing devices are configured to process the input as real numbers 304-1, . . . , 304-n as a set of integers. In other words, when the computing device receives input as real numbers, the computing device would represent the real number as a floating-point number with a floating-point representation having three integers. However, example embodiments may explicitly implement the integer conversion module 306 to convert the input as real numbers into a computing device format (e.g. a set of three integers) for further processing and manipulation.

The floating-point numbers 102-1, . . . , 102-n are provided to the preliminary fixed-point conversion module (or manager, component, etc.) 308 to generate preliminary fixed-point numbers (328-1, . . . , 328-n). A preliminary fixed-point number (328-1, . . . , 328-n) is generated for each floating-point number (102-1, . . . , 102-n). Each preliminary fixed-point number 328-1, . . . , 328-n comprises a shared fraction component 208, a sign component 108, and a preliminary mantissa component 324.

The value of the sign component 108 can be constant throughout the conversion (e.g. the value of the sign for the floating-point number is the same as the value of the sign component of the respective dynamic fixed-point number). The preliminary fixed-point conversion module 308 determines the shared fraction component 208 as the value of floating-point exponent component 106 having the maximum value across all floating-point numbers 102-1, 102-2, . . . , 102-n.

After determining the value of the shared fraction component 208, the value of the preliminary mantissa component 324 is the shifted version of the value of the floating-point mantissa component 104. The amount of shifting is the subtraction value of the value of floating-point exponent component 106 from the value of the shared fraction component 208. The value of the floating-point mantissa component 104 is shifted to the right a number of times equal to the subtraction value.

For example, if the shared fraction component 208 has a value of 5 in decimal and the floating-point number 102-1 has a value of floating-point exponent component 106 of 3 in decimal, then the subtraction value is 2 in decimal. The value of the preliminary mantissa component 324 is determined by shifting the binary value of the decimal value of the floating-point mantissa component 104 twice to the right. For instance, if the value of the floating-point mantissa component 104 is 0010100 then preliminary mantissa component 324 has a value 0000101.

Conventionally, a floating-point number 102-1, . . . , 102-n is normalized, e.g. the respective set of integers used to represent the floating point number 102-1, . . . , 102-n has a value of the floating-point mantissa component 104 starting with binary 1. This normalization is traditionally achieved by shifting the value of the mantissa component (in binary) to the left until the most significant bit is 1 (binary). For every shift to the left, the value of the floating-point exponent component 106 is reduced by 1. Therefore, the processes performed by the preliminary fixed-point conversion module 308 may reverse the normalization of the set of integers used to represent each floating point number (102-1, . . . , 102-n) .This is different from the conventional approach, which maintains a normalized value of the floating-point mantissa when possible. Therefore, the process performed by the preliminary fixed-point conversion module 308 may be the opposite of the conventional approach, which maintains a normalized floating-point mantissa. In other words, conversion by the preliminary fixed-point conversion module 308 may de-normalize the value of the floating-point mantissa component 104 to maintain a shared fraction component 208 having a value shared by all floating-point numbers 102-1, . . . , 102-n.

The preliminary mantissa component 324 is represented with the same number of bits (e.g. 23-bit) as the floating-point mantissa component 104 in floating-point numbers 102-1, . . . , 102-n, e.g. 23 bits, if the IEEE754 standard is used. Therefore, the preliminary fixed-point number 328-1, . . . , 328-n, the output of the preliminary fixed-point conversion module 308, is further rounded by the rounding module 310 to generate the dynamic fixed-point numbers 312-1, . . . , 312-n, represented with a fewer number of bits (e.g. dynamic fixed-point mantissa component represented with 7-bit).

The rounding module (or manager, component, etc.) 310 rounds the value of the preliminary mantissa component 324 to generate the value of the dynamic fixed-point mantissa component 204. The dynamic fixed-point mantissa component 204 refers collectively to the mantissa component of dynamic fixed-point numbers. Individually, the dynamic fixed-point mantissa component can be referred to by 204-1, 204,-2, . . . , 204-n as in FIG. 2.

The rounding operations in the rounding module 310 are performed to conform to a desired number of bits to represent the dynamic fixed-point mantissa component 204. The preliminary mantissa component 324 may have a value represented by more bits than the desired number of bits for the dynamic fixed-point mantissa component 204. The rounding module 310 rounds the value of the preliminary mantissa component 324 to generate the value of the dynamic fixed-point mantissa component 204. Example embodiments have the dynamic fixed-point mantissa component 204 having fewer bits than the floating-point mantissa component 104. There are several methods for rounding a floating-point number, including round nearest tie to away, round to nearest tie to even, stochastic rounding, etc.

It is understood that there are several rounding methods, and custom rounding methods may be implemented as well. The stochastic rounding is explained as it is used in some of the example embodiments. However, a person skilled in the art will understand that using stochastic rounding is not a limitation, and other rounding methods may be equally applicable. Stochastic rounding is a rounding method where the expected value of the value of the dynamic fixed-point mantissa component 204 is the value of the dynamic fixed-point mantissa component 204. Therefore, in example embodiments where the stochastic rounding method for a gradient is calculated, the value of the gradient is not distorted by the rounding operation. Hence, stochastic rounding can be useful in machine learning applications when several, and perhaps low precision, arithmetic operations are performed iteratively. If the value of the preliminary mantissa component 324 is x and x₁ and x₂ are two adjacent values smaller and bigger than x, respectively, then x, which is the value of the dynamic fixed-point mantissa component 204, is rounded up to x₂ with a probability of

$$\frac{x - {x}_{1}}{{x}_{2} - {x}_{1}}$$

and rounded down to x₁ with probability of

$$\frac{{x}_{2} - x}{{x}_{2} - {x}_{1}} .$$

Although example embodiments are discussed for floating-point numbers having the IEEE754 standard, the quantization module 302 may be equally applicable to other floating-point representations, e.g. IEEE float 16, “IEEE Computer Society. ‘IEEE Standard for Floating-Point Arithmetic,’ IEEE Std 754-2008 (2008): 1-70” incorporated in its entirety herein by reference, and BFloat “Kalamkar, Dhiraj, et al. and ‘A study of BFLOAT16 for deep learning training,’ arXiv preprint arXiv:1905.12322 (2019)” incorporated in its entirety herein by reference.

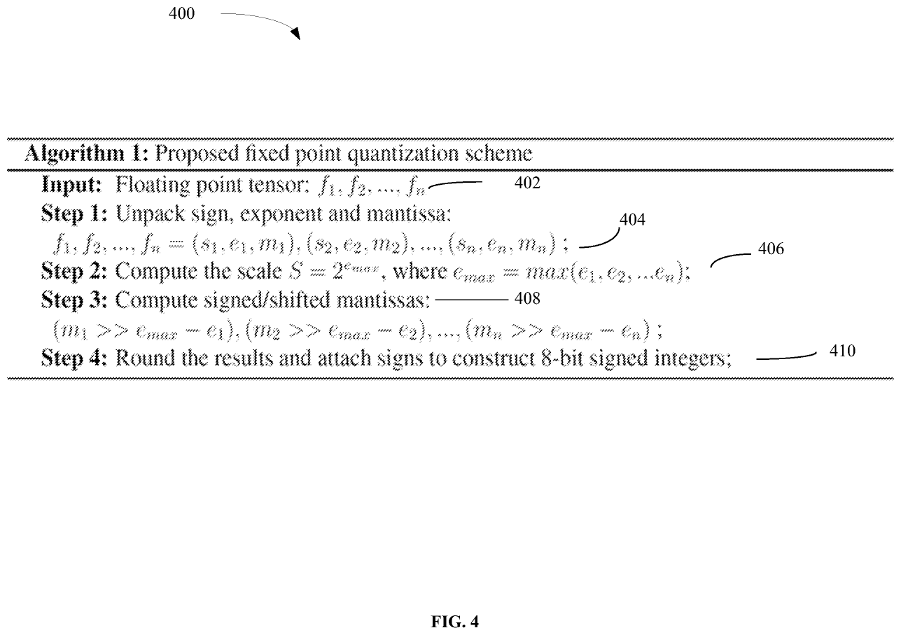

FIG. 4 is an example algorithm 400 for the quantization method that converts floating-point numbers into dynamic fixed-point numbers. At step 402, the quantization module 302 receives “n” floating-point numbers (f₁, f₂, . . . , fₙ), the floating-point numbers are received by the integer conversion module 306 at step 404. The integer conversion module 306 extracts a set of integers from each floating-point number (f₁, f₂, . . . , fₙ). Each set of integers comprises a sign component (s₁, s₂, . . . , sₙ), a floating-point exponent component (e₁, e₂, . . . , eₙ), and a floating-point mantissa component (m₁, m₂, . . . , mₙ). Therefore, each floating-point number is represented as a set of integers f₁=(s₁, e₁, m₁).

Processes for step 406 may be performed by the preliminary fixed-point conversion module 308. At step 406, a scale, which is also referred to as the shared fraction component, is determined. The value of the shared fraction component S=2^{e}^{ₘₐₓ}, where eₘₐₓ=max(e₁, e₂, . . . , eₙ).

At step 408, the value of the floating-point mantissa component (m₁, m₂, . . . , mₙ) is shifted based on the subtraction value of the respective floating-point exponent component and eₘₐₓ to generate a respective value of the preliminary mantissa component. For example, m₁ will be shifted a number of times depending on the value of eₘₐₓ−e₁ to generate a preliminary mantissa m₁′. Similarly, the values of preliminary mantissa m₂′, m₃′, . . . , mₙ′ are determined. If the subtraction value is positive, the floating-point mantissa component is shifted to the right.

A person skilled in the art will understand that the floating-point mantissa value is shifted to conform to the value of the shared fraction components because the floating-point mantissa value is represented in the binary system. If the floating-point mantissa value is represented in a decimal number, then a division or multiplication by the base, 10 for decimal, substitute the shifting. For instance, multiplying a decimal number by 10 is similar to shifting a binary number to the left, and dividing the decimal number by 10 is similar to shifting a binary number to the right. Further, a person skilled in the art will understand that using binary numbers and respective shifting operations are just examples and not meant to be limiting. Other numeral systems (e.g. hexadecimal, octal, decimal, etc.) may be equally applicable. Consequently, the counterpart of the shifting in the binary system may be used for the respective numeral system.

At step 410, the values of the preliminary mantissa components (m₁′, m₂′, . . . , mₙ′) (not shown in FIG. 4) are rounded based on the desired number of bits of the dynamic fixed-point mantissa component representing the dynamic fixed-point number. At step 410, the algorithm 400 uses 8-bits to represent both the sign component (1 bit) and the dynamic fixed-point mantissa component (7 bits). Therefore, the value of the preliminary dynamic fixed-point component is rounded to 7 bits.

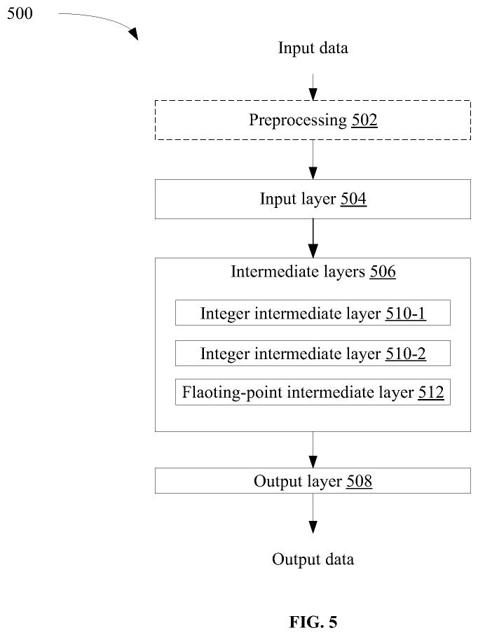

FIG. 5 is a schematic diagram illustrating an example structure and data flow through a deep learning model 500, which could be a deep learning model. The deep learning model 500 has been simplified and is not intended to be limiting and is provided for illustration only. The deep learning model 500 can be trained for inference-making. The input data to the deep learning model 500 may be, for example, image data, video data, audio data, or text data. Therefore, the input data, also referred to as data samples, can be in floating-point or fixed-point representation. The deep learning model 500 may optionally include a preprocessing 502, which may perform various operations to prepare the input data for the input layer 504. The deep learning model 500 comprises a number of layers, including the input layer 504, a plurality of intermediate layers 506, and an output layer 508. Example embodiments can have two types of intermediate layers 506: integer intermediate layer 510-1 and 510-2 and a floating-point intermediate layer 512.

An integer layer may be a layer that receives or converts input into dynamic fixed-point representation and performs integer computations. For example, such integer layer could be integer intermediate layer 510-1, 510-2 or integer input layer (not shown) and integer output layer not shown. Further, a floating-point layer may be a layer that receives input in floating-point representation and performs floating-point operations. Examples of floating-point layers are the floating-point intermediate layer 512, input layer 504, and output layer 508.

This example embodiment discusses the operations mainly performed by the plurality of intermediate layers 506. Hence, the plurality of intermediate layers 506 have integer intermediate layer 510 and floating-point intermediate layer 512. However, an example embodiment may have the input layer 504 and the output layer 508 to have an integer nature and perform integer computations. It is appreciated that a person skilled in the art will understand that the same methods implemented for the quantization module 302, de-quantization module 626, and layer output and gradient computation module 620 can be equally implemented for the input layer 504 and output layer 508 and make respective input layer 504 and output layer 508 as integer layers.

Each layer (input layer 504, intermediate layer 506, output layer 508) performs at least some of the computations within the deep learning model 500 using data represented with dynamic fixed-point representation generated using the quantization module 302 illustrated in FIG. 3. In this example embodiment, the layers that use dynamic fixed-point representation are integer intermediate layers 510-1 and 510-2. The input layer 504 receives the processed data from the optional preprocessing 502. To further emphasize, while this example embodiment teaches the dynamic fixed-point representation and operation thereof being used in the integer intermediate layers 510-1 and 510-2, a person skilled in the art will understand that the dynamic fixed-point representation and respective operations may be performed in the input layer 504 and output layer 508.

The preprocessed data from the input layer 504 are input to a plurality of intermediate layers 506. The first intermediate layer, integer intermediate layer 510-1 receives the preprocessed data output of the input layer 504, processes the input from the input layer 504, and outputs a first output data representation, which is input to the integer intermediate layer 510-2. The integer intermediate layer 510-2 receives the first output data representation, processes the first output data representation, and outputs a second output data representation, which is input to the floating-point intermediate layer 512. The floating-point intermediate layer 512 receives the second output data representation, processes the second output data representation, and outputs a third output data representation. The output layer 508 follows the plurality of intermediate layers 506. The output layer 508 receives the third output data representation from the floating-point intermediate layer 512 and processes the third output data representation to generate logits and output predictions for which the deep learning model 500 is trained to predict. Logits are unprocessed predictions of deep learning model 500. The output layer 508 passes the logits into a function, such as a softmax function, to transform the logits into probabilities. The output layer 508 is the final layer of the deep learning model 500.

While the output layer 508 of this example embodiment processes the third output data representation from the floating-point intermediate layer 512 to generate logits then passes the logits into a function, example embodiments may describe the output layer 508 as a function that transforms the third output data representation into probabilities.

In this disclosure, the deep learning model 500 comprises an input layer, a plurality of intermediate layers, and an output layer; however, the examples disclosed herein may be implemented for a larger machine learning models, including deep learning models such as deep neural network such as transformers and convolutional neural networks.

The integer intermediate layers 510-1 and 510-2 quantize the input of respective integer intermediate layers 510-1 and 510-2, perform forward propagation and backpropagation operations explained below using integer computations, de-quantize the output into floating-point numbers, and pass the de-quantized output to the subsequent layer. On the other hand, the floating-point intermediate layer 512 performs floating-point operations using data in floating-point representation. Therefore, the floating-point intermediate layer 512 does not perform quantization of input or de-quantization of output.

The quantization method implemented in the quantization module 302 may be used in the integer intermediate layers 510-1 and 510-2 to convert floating-point numbers into dynamic fixed-point numbers.

Hence, some of the computations of forward propagation and backpropagation performed in the deep learning model 500 may be performed using data (e.g. data samples) having dynamic fixed-point representation rather than floating-point representation. Generating the deep learning model 500 through training having dynamic fixed-point representation is much faster since integer computations are performed rather than floating-point operations; hence, these types of computations are a mixed-precision training of a machine learning model, or in embodiments, a deep learning model using integer format.

For ease of understanding, the following describes some concepts relevant to the deep learning model 500, which is a deep learning model and some relevant terms that may be related to examples disclosed herein.

As discussed above, a deep learning model may include layers of neurons in the intermediate layers 506, including integer intermediate layers 510-1, 510-2, and floating-point intermediate layer 512. A layer is a module that uses xₛ as inputs. An output may be provided based on the below equation:

$${h}_{W , b} ( x ) = f ( {W}^{T} x ) = f ( {\sum }_{s = 1}^{n} {W}_{s} {x}_{s} + b ) \qquad ( 1 )$$

where s=1, 2, . . . , n, n is a natural number greater than 1, Wₛ, is a weight of xₛ, b is an offset (i.e., bias) of the layer, and f is an activation function of the layer and used to introduce a nonlinear feature to a respective layer's input xₛ. The output of the activation function may be used as an input for the subsequent layer in the deep learning model 500. It is to be understood that most of the values of Wₛ, xₛ, and b are represented in floating-point representation. However, example embodiments of the present disclosure convert Wₛ, xₛ, and b into dynamic fixed-point representation, and perform the computations of equation (1) using integer computations. Details on computations using the dynamic fixed-point representation are explained below.

The deep learning model 500 of this example is technically not very deep, it includes of an input layer 504, intermediate layers 506 of three layers, and an output layer 508. Therefore, the deep learning model 500 is just an example, and not meant to be a limitation. In other deep learning models, the intermediate layers 506 may have many more layers. For example, a deep neural network (DNN) is similar to deep learning model 500 but has many more intermediate layers 506. The layers (e.g. input layer 504, intermediate layers 506, and output layer 508) are considered fully connected when there is a full connection between two adjacent layers of the deep learning model 500. To be specific, for two adjacent layers (e.g., the i-th layer and the (i+1)-th layer) to be fully connected, each and every neuron in the i-th layer must be connected to each and every neuron in the (i+1)-th layer.

Values of Wₛ and xₛ are conventionally in floating-point representation, for example, IEEE754 representation, which requires at least 32-bit for each number. In the deep learning model 500, Wₛ and xₛ are in floating-point representation in the floating-point intermediate layer 512. Computation related to such numbers, for example, the computations in equation (1) are performed in floating-point representation using floating-point operations. However, the values of Wₛ and xₛ are converted into dynamic fixed-point numbers. Further, integer computations are performed in integer intermediate layers 510-1 and 510-2.

More intermediate layers in a DNN may enable the DNN to better model a complex situation (e.g., a real-world situation). In theory, a DNN with more parameters is more complex, has a larger capacity (which may refer to the ability of a learned model to fit a variety of possible scenarios), and indicates that the DNN can complete a more complex learning objective. Training of the DNN is a process of learning the weight matrix.

Referring back to the deep learning model 500, the purpose of the training is to generate a trained machine learning model which consists of parameters with the values of learned weights Wₛ of all layers of deep learning model 500 and biases b.

Training is the process of generating a deep learning model 500. All deep learning model's learnable parameter values are initialized; parameters include Wₛ and b. The deep learning model 500 is trained over multiple epochs. A full corpus of training data is split into multiple training and validation batches during each epoch. The training includes two primary steps for each epoch: performing forward propagation and backpropagation. The methods discussed in this disclosure teach using, partly or fully, integer computations during forward propagation and backpropagation. Using integer computations is performed by converting real numbers represented in floating-point representation into real numbers represented in dynamic fixed-point representation.

In the forward propagation, each batch of training data is passed through the deep learning model 500 from the input layer to the output layer to generate outputs. The outputs of the deep learning model 500, which are predicted values, are compared to desired target values (e.g., ground-truth values available in the training dataset), and an error (loss) is computed. The loss is a way to quantitatively represent how close the predicted values are to the target values. After computing the loss, the loss is backpropagated to adjust the weights Wₛ and biases b of the neural network model before receiving the next batch of training data. During backpropagation, the gradient of the loss with respect to each weight of the weights Wₛ is calculated and subtracted from the respective weight Wₛ. When data is passed through an integer layer, for example, integer intermediate layer 510-1 and integer intermediate layer 510-2, integer computations are performed rather than floating-point operations. Performing integer computations applies during forward propagation and backpropagation. Even the gradients for the integer layers are computed using integer computations in order to accelerate the training, save energy and reduce the memory footprint.

Further, suppose a defined loss function is calculated from forward propagation of an input layer to an output layer of the deep learning model 500, backpropagation calculates a gradient of the loss function with respect to the learnable parameters (e.g. Wₛ and b) of the deep learning model 500, and a gradient algorithm (e.g., gradient descent) is used to update the learnable parameters to reduce the loss function. Backpropagation is performed iteratively so that the loss function is converged or minimized. For integer layers, the learnable parameters in backpropagation are updated using integer computations using data having fixed-point numbers.

Optimizing the deep learning model 500 is performed by repeating the forward propagation and backpropagation of batches until all batches of the epoch are processed. Through model optimization over multiple epochs, the weights Wₛ and biases b of the deep learning model 500 may converge to an equilibrium state, indicating that the deep learning model 500 has been optimally trained relative to the complete set of training data samples and generated the neural network model.

In example embodiments, the optimization may be performed using stochastic gradient descent (SGD), where all operations for integer layers are performed using integer computations using data having dynamic fixed-point representation. When SGD is used for integer layers, all the functionalities of the optimizer, e.g. momentum, weight update, weight decay, are computed using integer computations using data having dynamic fixed-point numbers.

The deep learning model 500 has the first and second intermediate layers (integer intermediate layers 510-1 and 510-2) and the third intermediate layer as floating-point intermediate layer 512. It is understood to a person skilled in the art that this is just an example, and many more intermediate layers 506 can exist in different sequences. If all intermediate layers 506 are floating-point intermediate layer 512 then that may be the conventional neural network commonly available. The deep learning model 500 generated through training with methods described above can be used during inference making to make a prediction for input data.

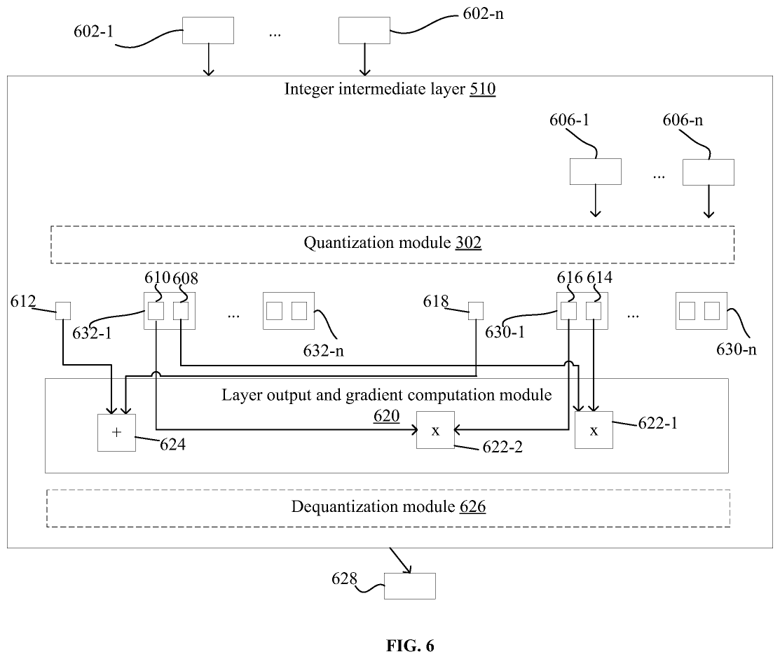

FIG. 6 illustrates a block diagram of an integer layer, e.g. integer intermediate layer 510, which could be integer intermediate layers 510-1 or 510-2. The integer intermediate layer 510 (refer to either integer intermediate layer 510-1 or 510-2) may make the training of the deep learning model feasible since using integer intermediate layer 510 decreases memory footprint and reduces computational power energy needed to perform computations.

The layer output and gradient computation module (or manager, component, etc.) 620 may receive the dynamic fixed-point weights 630-1, . . . , 630-n and the dynamic fixed-point feature vector 632-1, . . . , 632-n and may compute the output of the layer as in equation (1). Example embodiments may compute the output of a layer using parallel computations and matrix multiplications. With reference to equation (1), for Σₛ₌₁ⁿ=Wₛxₛ of equation (1), the values of the weights (Wₛ) and values of the feature vector xₛ can be converted into dynamic fixed-point numbers, such that each value of the Wₛ can be represented by e_{w,max}, signal_{w}, and mₑ′, where e_{w,max} is the maximum fraction value extracted from all floating-point exponent components of Wₛ. Therefore, the subscript “w” indicates that the respective value is for a weight value. Similarly, the xₛ can be represented with respective e_{x,max}, sₓ, m′ₓ.

It is worth mentioning that the weight values 630-1, . . . , 630-n and feature vector values 602-1, . . . , 602-n may be processed in the integer intermediate layer 510, represented as dynamic fixed-point weights and dynamic fixed-point feature vector, respectively. The dynamic fixed-point weights have a shared fraction component shared among all weights, a respective sign component and a respective dynamic fixed-point mantissa component. Similarly, the dynamic fixed-point feature vector has a shared fraction component for all values in the feature vector, a respective sign component, and a respective dynamic fixed-point mantissa component. The dynamic fixed-point mantissa component may be represented with fewer bits than the floating-point mantissa component. Therefore, representing the weights and feature vectors in dynamic fixed-point representation optimizes computing device resources and may use fewer memory resources for at least two reasons. First, a shared component fraction may be used, and second, the dynamic fixed-point mantissa component may have fewer bits than the floating-point mantissa component. When applied to deep learning models, where millions of weights are used, a significant amount of storage can be saved in both training and inference-making (inference mode).

$$Therefore , {\sum }_{s = 1}^{n} {W}_{s} {x}_{s} = {\sum }_{s = 1}^{n} {( {e}_{max , w} , {sign}_{w} , {m}_{w}^{′} )}_{s} {( {e}_{max , x} , {sign}_{x} , {m}_{x}^{′} )}_{s} . \qquad ( 2 )$$

$$Further , {\sum }_{s = 1}^{n} {( {e}_{max , w} , {sign}_{w} , {m}_{w}^{′} )}_{s} {( {e}_{max , x} , {sign}_{x} , {m}_{x}^{′} )}_{s} = {2}^{( {e}_{max , w} + {e}_{max , x} )} {\sum }_{s = 1}^{n} {( {sign}_{w} , {m}_{w}^{′} )}_{s} {( {sign}_{x} , {m}_{x}^{′} )}_{s} .$$

$$Hence , {\sum }_{s = 1}^{n} {W}_{s} {x}_{s} = {2}^{( {e}_{max , w} + {e}_{max , x} )} {\sum }_{s = 1}^{n} {( {sign}_{w} , {m}_{w}^{′} )}_{s} {( {sign}_{x} , {m}_{x}^{′} )}_{s}$$

It is worth noting the shared fraction component has a value of the exponent's power. Therefore, the powers are summed when multiplying the exponents, hence, e_{w,max}+e_{x,max}.

The layer output and gradient computation module 620 shows an example for multiplying one dynamic fixed-point weight 632-1 with one value of dynamic fixed-point feature vector 630-1. Therefore, as indicated in equation (2), the value of the weight dynamic fixed-point mantissa component 614 and the value of the feature vector dynamic fixed-point mantissa component 608 are multiplied using product operation module 622-1. Further, the value of weight sign component 616 and the value of the feature vector sign component 610 are multiplied using product operation module 622-2. The value of feature vector shared fraction component 612 and the value of the weight shared fraction value 618 are summed in the summation operation module 624. The product operation modules 622-1 and 622-2 perform product operations, and the summation operation module 624 performs addition operations.

Equation (2) explains matrix multiplication. However, it is to be understood by a person skilled in the art that other computations can equally be performed using integer computations using data having dynamic fixed-point representation. Therefore, it is clear that multiplication is just an example and not intended to be limiting. For example, integer computations can be equally applicable to other layers such as convolutional, skip connection, embedding, and batch-norm layers in forward propagation and backpropagation.

The de-quantization module (or manager, component, etc.) 626 is an optional module that converts a real number represented in dynamic fixed-point representation (also referred to as dynamic fixed-point number). The dynamic fixed-point number to a real number in floating-point representation (also referred to as floating-point number). The dynamic fixed-point number can be the output of the layer output and gradient computation module 620, which is passed to the subsequent layer (e.g. output layer 508 or intermediate layer 506). The output of the de-quantization module 626 in FIG. 5 is shown to be within the layer, hence, converting the output of the layer into a floating-point number. The output of the de-quantization module 626 of FIG. 6 is an output floating-point number 628, passed to the subsequent layer of the deep learning model 500.

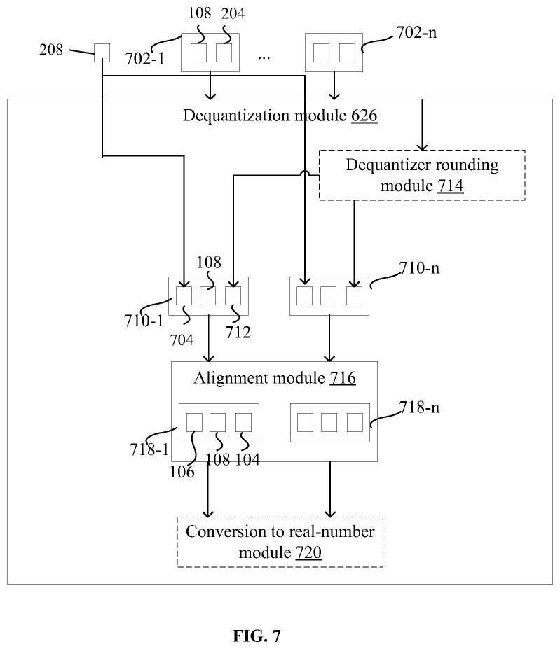

FIG. 7 is a block diagram of a de-quantization module 626. The de-quantization module 626 may receive input data 702-1, . . . , 702-n, which can be a tensor. The input data is represented as a floating-point number with a floating-point representation having a sign component 108, and a dynamic fixed-point mantissa component 204. The input data 702-1, . . . , 702-n share a shared fraction component 208. The purpose of the de-quantization module is to convert numbers from a dynamic fixed-point representation to a floating-point representation similar in format to floating-point numbers 102-1, . . . , 102-n, then pack the floating-point numbers as real numbers and what computing devices expect as input.

The de-quantization module 626 first generates preliminary floating-point numbers 710-1, . . . , 710-n having the sign component 108 of the respective dynamic fixed-point number 702-1, . . . , 702-n. Further, the preliminary floating-point numbers 710-1, . . . , 710-n have the value of the shared fraction component 208 for the value of each preliminary floating-point exponent component 704 of preliminary floating-point numbers 710-1, . . . , 710-n. The dynamic fixed-point mantissa component 204 of the data input 702-1, . . . , 702-n are fed to an optional de-quantizer rounding module 714 to round the value of the dynamic fixed-point mantissa component 204 and generate the respective value of the preliminary floating-point mantissa component 712 of each preliminary floating-point number 710-1, . . . , 710-n.

The de-quantizer rounding module (or manager, component, etc.) 714 rounds the value of dynamic fixed-point mantissa of respective dynamic fixed-point numbers 702-1, . . . , 702-n to the desired number of bits to represent the preliminary floating-point mantissa component 712 of the preliminary floating-point numbers 710-1, . . . , 710-n. The value of dynamic fixed-point mantissa component 204 may have extra bits generated from the various multiplication operations performed on the dynamic fixed-point numbers 702-1, . . . , 702-n; hence, the value of the dynamic fixed-point mantissa component 204 may be rounded (e.g. using stochastic rounding). Further, the preliminary floating-point mantissa component 702 may be represented with more bits than the number of bits to represent the dynamic fixed-point mantissa component 204. In such a scenario, the de-quantizer rounding module 714 pads the value of dynamic fixed-point mantissa component 204 with zeros to generate the value of the preliminary floating-point mantissa component 712. There are several methods for rounding a number described above for the quantization module 302.

The alignment module (or manager, component, etc.) 716 normalizes the preliminary floating-point numbers 710-1, . . . , 710-n to generate respective output floating-point numbers 718-1, . . . , 718-n. The output floating-point numbers 718-1, . . . , 718-n are normalized floating-point numbers. A normalized floating-point number is an integer set with a floating-point mantissa value starting with binary 1. This normalization is achieved by shifting the value of preliminary floating-point mantissa component 712 (in binary) to the left until the most significant bit is 1 (binary). For every shift to the left, the preliminary floating-point exponent value 704 is reduced by 1. For illustration, if the preliminary floating-point mantissa component 712 is of 5 bits with a value of 5, i.e., 00101, then the preliminary floating-point mantissa value is shifted to the left twice to become 10100, and accordingly, the preliminary floating-point exponent value is adjusted by 2⁻². The generated output floating-point numbers 718-1, . . . , 718-n (normalized floating-point values) can have a floating-point mantissa value of 10100 with a floating-point exponent value of the preliminary floating-point exponent value 704 reduced by 2. If alignment module 716 cannot align (normalize) the preliminary floating-point numbers 710-1, . . . , 710-n, the output floating-point number 718-1, . . . , 718-n may be a subnormal floating-point value 718-1, . . . , 718-n. Subnormality occurs when the adjustment to the preliminary floating-point exponent value would be out of the range of value that can be represented, e.g., an exponent of less than e⁻¹²⁷. In this situation, the subnormal floating value is carried over for the next computations.

Each of the output floating-point numbers 718-1, . . . , 718-n is represented by a sign component 108, a floating-point exponent component 106, and a floating-point mantissa component 104. Each sign component 108, floating-point exponent component 106, and floating-point mantissa component 104 has an integer value. However, the input as real numbers, e.g. 304-1, . . . , 304-n, are represented by a value with an exponent (e.g. 1984 e−3). Therefore, the conversion to real-number module 720 packs the final floating-point numbers 718-1, . . . , 718-n into real numbers that computing devices expect to receive. In other words, the conversion to real-number module 720 converts an input of a set of integers into a real number. It is understood by a person skilled in the art that the conversion to real-number module 720 is an optional module as computing devices may accept the input as a set of integers. For similar reasoning, the integer conversion module 306 is optional.

Referring back to FIG. 5, training the deep learning model 500 may include forward propagation by processing the input data from the preprocessing 502 to the output layer 508, then backpropagating the loss from the output layer 508 to the input layer 504. The example embodiment of FIG. 5 shows the deep learning model 500 having two types of intermediate layers: integer intermediate layers 510-1, 510-2, and floating-point intermediate layer 512. The integer intermediate layers 510-1 and 510-2 are as described in FIG. 6, and the floating-point intermediate layer 512 may be a conventional intermediate layer that performs operations for data represented as floating-point numbers. In the example embodiments of the integer intermediate layer 510, both forward propagation and backpropagation perform operations on data represented by integer numbers (e.g. perform quantization in the quantization module 302, integer computations in the layer output and gradient computation module 620, and de-quantization in the de-quantization module 626).

In some example embodiments, instead of the integer intermediate layer 510, a hybrid intermediate later (not shown) is implemented. The hybrid intermediate layers may behave as integer intermediate layer 510 in forward propagation and floating-point intermediate layer 512 during backpropagation. The hybrid intermediate layers may also behave as a floating-point intermediate layer 512 during forward propagation and an integer intermediate layer 510 during backpropagation.

The quantization module 302 and the de-quantization module 626 are shown as optional components in FIG. 6 as it may save resources in some embodiments not to perform the operations of the quantization module 302 or the de-quantization module 626. In the example embodiment of FIG. 5, where two consecutive integer intermediate layers 510-1 and 510-2 are present, the integer intermediate layer 510-1 may not need the de-quantization module 626 during forward propagation and backpropagation when passing data between these two consecutive integer intermediate layers 510-1 and 510-2. Further, the integer intermediate layer 510-2 may not need the quantization module 302. A person skilled in the art will understand that in these scenarios, if the weights 606-1, . . . , 606-n are not in dynamic fix-point representation, then the quantization module 302 may need to be available and the operations performed by the quantization module 302 may need to be performed for the weights 606-1, . . . , 606-n. Therefore, a person skilled in the art will understand when the quantization module 302 and the de-quantization module 626 can be redundant and not having the quantization module 302 or the de-quantization module 626 can save computing resources.

In example embodiments, a machine learning model may be based completely on integer intermediate layers 510, including integer input layers and output layers. Hence, the machine learning model will be an integer machine learning model where all forward propagation and backpropagation operations are performed for data represented in dynamic fixed-point numbers. For such example embodiments, a quantization module 302 may be available in the integer intermediate layer 510-1, which receives input from the input layer 504. Also, one de-quantization module 626 may be available in the integer intermediate layer 510-2, whose output is passed to the output layer 508.

Such machine learning models may be of great interest as they replace all 32-bit floating-point values with lower bits represented by dynamic fixed-point values, which can be 8 bits.

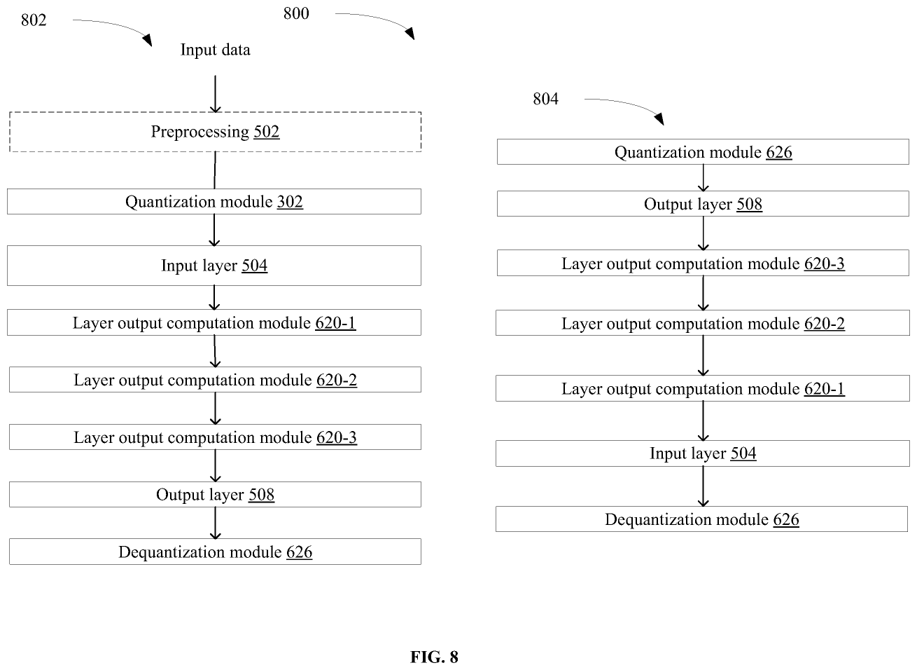

FIG. 8 is another example data flow of an integer machine learning model 800 in the forward propagation 802 and backpropagation 804. In the forward propagation 802, the input data is processed in the preprocessing 502 and quantized in the quantization module 302. The quantized processed input data is received by the intermediate layers 506 to perform layer computations. Since the data (e.g. quantized processed input data) is quantized, such data is represented in dynamic fixed-point representation. Any subsequent operations in integer layers are performed using integer computations. In this example embodiment, the quantized processed input data is subsequently processed in the layer output and gradient computation modules 620-1, 620-2, 620-3. Each layer output and gradient computation module 620-1, 620-2, 620-3 may have respective layer weights. The operations performed in each layer output and gradient computation module 620-1, 620-2, 620-3 are integer computations. Once the data is processed in the layer output and gradient computation module 620-3, the output of the layer output and gradient computation module 620-3, which may be in dynamic fixed-point representation, may be passed to the output layer 508, where loss is computed using integer computations. The output of the output layer 508 may also be in dynamic fixed-point representation. The output of the output layer 508 may be de-quantized in the de-quantization module 626 to floating-point numbers to compute the loss. The forward propagation 802 ends, and the backpropagation 804 begins.

In example embodiments, the loss may be computed using integer computations. In such example embodiments, the output of the output layer 508 may not be de-quantized, instead the ground-truth data, which is compared to the output of the output layer 508 to compute loss, may be quantized using the quantization module 302. After converting the ground-truth data to data in dynamic fixed-point representation, the converted ground-truth data and the output of the output layer 508, which are both in dynamic fixed-point representation, compute the loss using integer computations.

In the backpropagation 804, the computed loss is quantized in the quantization module 302 and used in an optimization method, such as gradient descent or stochastic gradient descent, to update the deep learning model's learnable parameters. For example, the optimization method is used to update the weights and biases (if exist) of the layer output and gradient computation modules 620-1, 620-2, 620-3, and weights and biases of the output layer 508 and input layer 504, if such weights and biases in the output layer 508 and input layer 504 exist. Updating the weights and biases using the optimization method is performed using integer computations. Further, the optimizer values generated by the optimizer method to update respective weights and biases may be in dynamic fixed-point representation.

In the backpropagation 804, the output of the input layer 504, may be de-quantized to floating-point numbers for further processing, if needed.

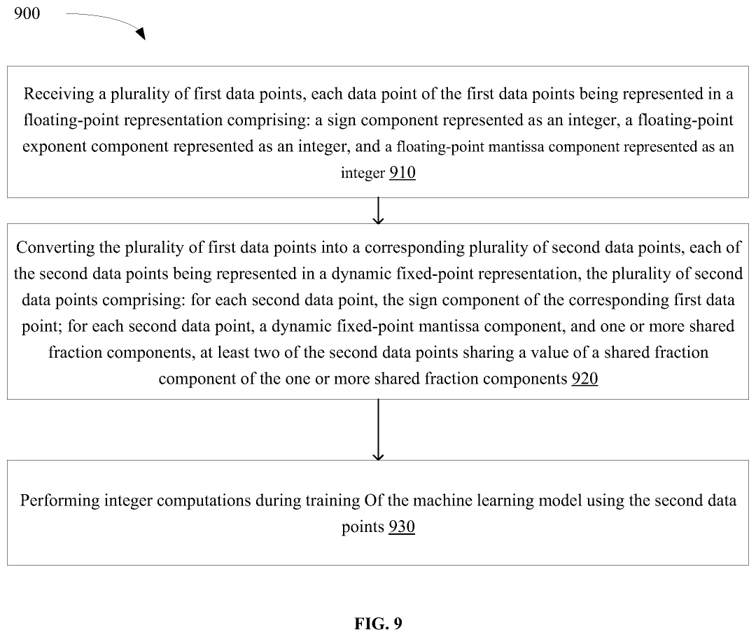

FIG. 9 is a flowchart of a training method 900 for training a machine learning model using an example embodiment of the present disclosure. The training method 900 starts at step 910 where a machine learning model, such as deep learning model 500, receives first data points. Each data point, the data points could be floating-point numbers 102-1, . . . , 102-n which are represented in a floating-point representation, e.g. IEEE754. Each of the first data points is represented as a floating-point number with floating-point representation as set of integers having a sign component, a floating-point exponent component, and a floating-point mantissa component.

At step 920, the computing device then converts the first data points into second data points. The second data points are data points being represented in a dynamic fixed-point representation. Each of the second data points may be represented as the sign component and a dynamic fixed-point mantissa component. Further, at least two of second data points share a value of a shared fraction component. In other words, the plurality of first data points are converted into a corresponding plurality of second data points. Each of the second data points is represented in a dynamic fixed-point representation. Each second data point has the sign component of the corresponding first data point. Also, each second data point has a dynamic fixed-point mantissa component. Further, one or more shared fraction components, at least two of the second data points sharing a value of a shared fraction component of the one or more shared fraction components. After converting the data points to the dynamic fixed-point representation at step 920, the method proceeds to step 930. At step 930, the computing device performs integer computations needed to train, including forward and backpropagation, the machine learning model using the second data points.

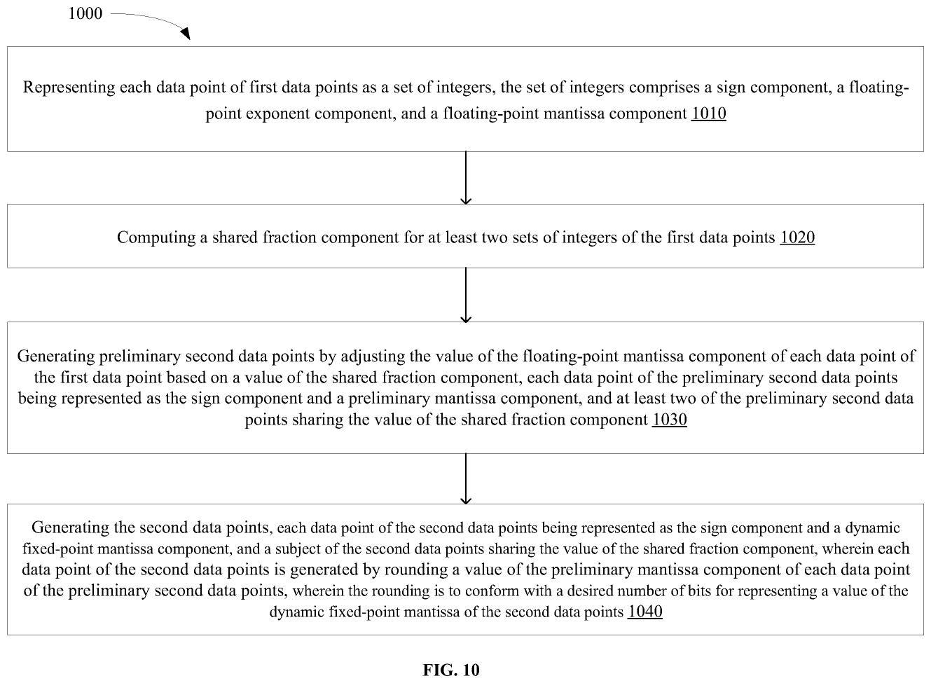

FIG. 10 is a flowchart of a conversion method 1000 for converting first data points having a first floating-point representation into second data points having a dynamic fixed-point representation. At step 1010, the computing device extracts a set of integers for each data point of the first data points. Each set of integers has a floating-point exponent component, a sign component, and a floating-point mantissa component.

At step 1020, the computing device computes a shared fraction component for at least two sets of integers of the first data points. The shared fraction component has a value of a maximum exponent value of the floating-point exponent components of the at least two sets of integers of the first data points.

At step 1030, preliminary second data points are generated. The preliminary second data points are generated by adjusting the value of the floating-point mantissa component of each data point of the first data point based on a value of the shared fraction component. Each data point of the preliminary second data point is represented as a sign component and a preliminary mantissa component. While each second data point has a respective sign and preliminary mantissa components, at least two of the respective preliminary second data points share the shared fraction component.

At step 1040, the preliminary second data points are further processed to generate the second data points, which are data points in the dynamic fixed-point representation. Each data point of the second data points is represented as the sign component and a dynamic fixed-point mantissa component, and a subset of the respective data points of the second data points share the value of the shared fraction component. At step 1040, the preliminary mantissa value of each preliminary second data point of the second data points is rounded to the number of bits desired for the value of the dynamic fixed-point mantissa component. After generating the second data points in dynamic fixed-point representation, the second data points may be used in performing integer computations instead of the first data points. When using the dynamic fixed-point representation, integer computations are performed, saving a significant amount of memory and making computations much faster than floating-point computations performed if first data points are used.

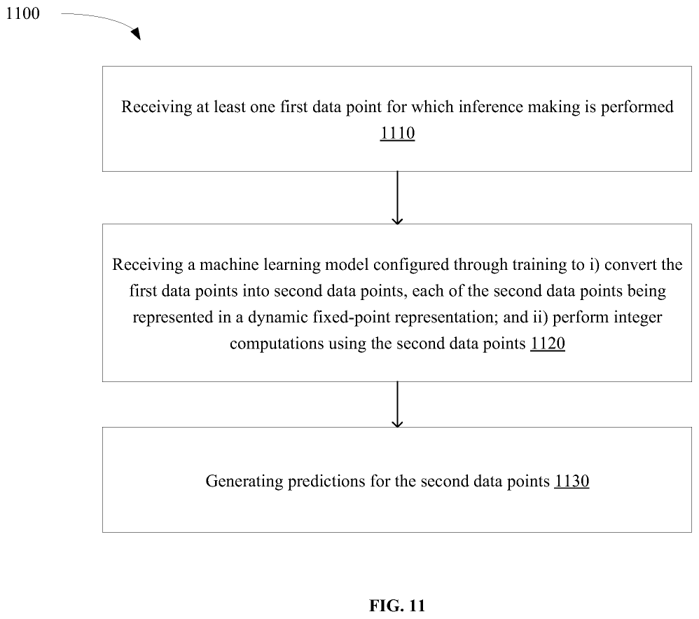

FIG. 11 is a flowchart for the inference-making method 1100. The inference-making method 1100 starts at step 1110 for which a machine learning model receives at least one first data point for which the inference-making is performed. In other words, the machine learning model receives the data for which predictions are desired.

At step 1120, the computing device receives a machine learning model configured through training to: i) convert the first data points into second data points; and ii) perform integer computations using the second data points. Each data point of the second data points is represented in a dynamic fixed-point representation.

At step 1130, the computing device uses the trained machine learning model and modules such as quantization module 302, de-quantization module 626, and layer output and gradient computation module 620 to generate predictions for the second data points.

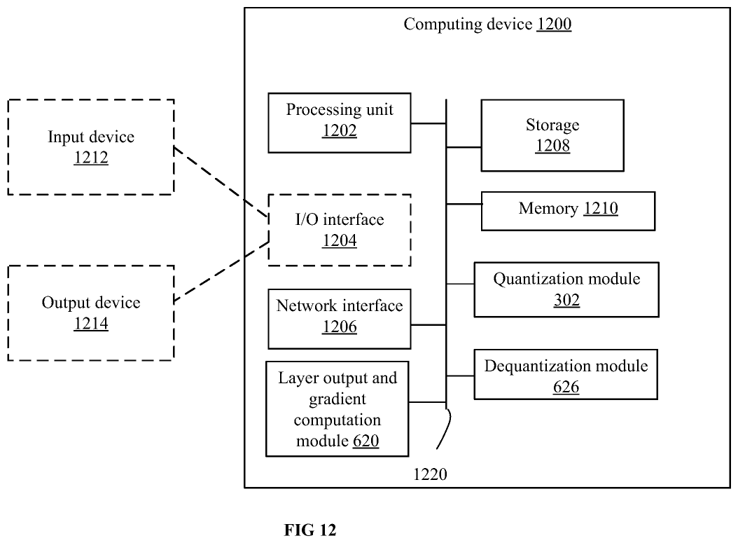

FIG. 12 is a block diagram illustrating a computing device 1200 implementing methods and systems of the present disclosure. The computing device 1200 includes and is configured to perform operations of modules used for converting data points from the floating-point representation into the dynamic fixed-point representation, such as the quantization module 302, de-quantization module 626, and layer output and gradient computation module 620. Therefore, the computing device 1200 is configured to train machine learning models and perform inference-making for such machine learning models using data having dynamic fixed-point representation. Performing methods of the present disclosure (e.g. the training method 900, conversion method 1000, and the inference-making method 1100), the computing device 1200 may not need to be altered in order to perform the integer computations as in counterpart computing devices.

A “module” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, an application-specific integrated circuit (ASIC), field-programmable gate array (FPGA), GPU (Graphical Processing Unit), or a system on a chip (SoC) or another hardware processing circuit.

The computing device 1200 may be an individual physical computer, multiple physical computers such as s server, a virtual machine, or multiple virtual machines. Dashed blocks represent optional components. Other computing devices suitable for implementing examples described in the present disclosure may be used, which may include components different from those discussed below. Although FIG. 12 shows a single instance of each component; there may be multiple instances of each component in the computing device 1200. Also, the computing device 1200 could be implemented using parallel and/or distributed architecture.

In this example, the computing device 1200 includes one or more processing units 1202, such as a CPU, GPU, an MCU, an ASIC, a field-programmable gate array (FPGA), and a dedicated logic circuitry, or combinations thereof. Each of the aforementioned processing units may include various hardware components, whether fabricated on-chip or separate. For instance, the CPU may include one or more accumulators, registrars, multipliers, decoders, and arithmetic and logic units. It is to be understood that other processing units, such as GPU, may include similar components.

Using the quantization module 302, de-quantization module 626, and layer output and gradient computation module 620, allow the computing device 1200 to perform computations for both training and inference-making based on dynamic fixed-point numbers (e.g. integer computations) rather than floating-point numbers (e.g. floating-point computations).

The computing device 1200 may also include one or more optional input/output (I/O) interfaces 1204, enabling interfacing with one or more optional input devices 1212 and/or output devices 1214. The computing device 1200 may include one or more network interfaces 1206 for wired or wireless communication with a network (e.g., an intranet, the Internet, a P2P network, a WAN and/or a LAN). The network interface(s) 1206 may include wired links (e.g., Ethernet cable) and/or wireless links (e.g., one or more antennas) for intra-network and/or inter-network communications for receiving parameters or sending results.

The computing device 1200 includes one or more storage units 1208, which may include a mass storage unit such as a solid-state drive, a hard disk drive, a magnetic disk drive and/or an optical disk drive. The computing device 1200 also includes one or more memories 1210, which may have a volatile or non-volatile memory (e.g., a flash memory, a random access memory (RAM), and/or a read-only memory (ROM)). The memory(ies) 1210 (as well as storage unit 1208) may store instructions for execution by the processing unit(s) 1202. The memory(ies) 1210 may include software instructions for implementing an operating system (OS) and other applications/functions. In some examples, instructions may also be provided by an external memory (e.g., an external drive in communication with the computing device 1200) or may be provided by a transitory or non-transitory computer-readable medium. Examples of non-transitory computer-readable media include a RAM, a ROM, an erasable programmable ROM (EPROM), an electrically erasable programmable ROM (EEPROM), a flash memory, a CD-ROM, or other portable memory storage.

The computing device 1200 shows the quantization module 302, de-quantization module 626, layer output and gradient computation module 620. The quantization module 302, de-quantization module 626, and the layer output and gradient computation module 620 may be (or have) instructions stored in memory 1210 when executed by the processing unit 1202 causes the processing unit 1202 to perform respective computations. The quantization module 302, de-quantization module 626 and layer output and gradient computation module 620 may be implemented in components of the computing device 1200 or may be offered as a software as a service (SaaS) by a cloud computing provider. The quantization module 302, de-quantization module 626 and layer output and gradient computation module 620 may also be available on servers accessed by the computing device 1200 through the network interface 1206. Further, the quantization module 302, de-quantization module 626, and the layer output and gradient computation module 620 may also be fabricated in hardware as part of the processing unit 1202.

Optional input device(s) 1212 (e.g., a keyboard, a mouse, a microphone, a touchscreen, and/or a keypad) and optional output device(s) 1214 (e.g., a display, a speaker and/or a printer) are shown as external to the computing device 1200 and connected to optional I/O interface 1204. In other examples, one or more of the input device(s) 1212 and/or the output device(s) 1214 may be included as a component of the computing device 1200.

There may be a bus 1220 providing communication among components of the computing device 1200, including the processing unit 1202, network interface(s) 1206, I/O interface 1204, storage unit 1208, and/or memory(ies) 1210. The bus 1220 may be any suitable bus architecture, including, for example, a memory bus, a peripheral bus or a video bus.

The disclosed methods may be carried out by modules, routines, or subroutines of software executed by the computing device 1200. Coding of software for carrying out the steps of the methods is well within the scope of a person of ordinary skill in the art having regard to the methods of training machine learning models and making inferences using the machine learning models. The training method 900, conversion method 1000, and inference-making method 1100 method may contain additional or fewer steps than shown and described, and the steps may be performed in a different order. Computer-readable instructions, executable by the processor(s) of the computing device 1200, may be stored in the memory 1210 of the computing device 1200 or a computer-readable medium. It is to be emphasized that the steps of the emulation engine method need not be performed in the exact sequence as shown unless otherwise indicated. Likewise, various steps of the methods may be performed in parallel rather than in sequence.

It can be appreciated that methods of the present disclosure (e.g. training method 900, the conversion method 1000, and the inference-making method 1100), once implemented, can be performed by the computing device 1200 in a fully automatic manner, which is convenient for users to use as no manual interaction is needed.

In the several embodiments described, it should be understood that the disclosed systems and methods may be implemented in other manners. For example, the described system embodiments are merely examples. Further, units or components may be combined or integrated into another system, or some features may be ignored or not performed. In addition, the displayed or discussed mutual couplings or direct couplings or communication connections may be implemented by using some interfaces. The indirect couplings or communication connections between the systems or units may be implemented in electronic, mechanical, or other forms.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

Also, although the systems, devices and processes disclosed training and inference making and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one computing device 1200, or each of the units may exist alone physically, or two or more units are integrated into one unit.

When the functions are implemented in the form of a software functional unit and sold or used as an independent product, they may be stored in a storage medium and include several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations but are not intended to limit the scope of protection. Any variation or replacement readily figured out by a person skilled in the art within the technical scope shall fall within the scope of protection. Therefore, the scope of protection shall be subject to the protection scope of the claims.

1. A computer-implemented method for training a machine learning model comprising:
receiving a plurality of first data points, each data point of the first data points being represented in a floating-point representation comprising:
a sign component represented as an integer,
a floating-point exponent component represented as an integer, and
a floating-point mantissa component represented as an integer;
converting the plurality of first data points into a corresponding plurality of second data points, each of the second data points being represented in a dynamic fixed-point representation, the plurality of second data points comprising:
for each second data point, the sign component of the corresponding first data point;
for each second data point, a dynamic fixed-point mantissa component, and
one or more shared fraction components, at least two of the second data points sharing a value of a shared fraction component of the one or more shared fraction components; and
performing integer computations during training of the machine learning model using the second data points.

2. The method of claim 1, wherein converting the first data points into second data points comprises:
generating preliminary second data points by adjusting the value of the floating-point mantissa component of each data point of the first data point based on a value of the shared fraction component, each data point of the preliminary second data points having the sign component and a preliminary mantissa component, and at least two of the preliminary second data points sharing the value of the shared fraction component.

3. The method of claim 2, wherein each data point of the second data points is generated by rounding a value of the preliminary mantissa component of each data point of the preliminary second data points, wherein the rounding is to conform with a desired number of bits for representing a value of the dynamic fixed-point mantissa component of the second data points.

4. The method of claim 3, wherein the rounding is stochastic rounding.

5. The method of claim 1, wherein the floating-point representation is based on the IEEE754 standard.

6. The method of claim 1, wherein the training comprises:
inputting the second data points into a machine learning model to forward propagate the second data points through the machine learning model and generate predictions for the second data points;
computing a loss based on the predictions and ground-truth labels of the second data points using integer computations; and
back-propagating the loss through the machine learning model to adjust values of parameters of the machine learning model using integer computations.

7. The method of claim 6, wherein the back-propagating comprises computing gradients, the gradients being computed using integer computations.

8. The method of claim 6, wherein the forward propagate comprises performing integer computations at a plurality of layers of the machine learning model.

9. The method of claim 8, wherein the plurality of layers include integer layers performing integer computations and floating-point layers performing floating-point computations.

10. The method of claim 6, wherein the backpropagation uses an optimization method to adjust the values of the parameters.

11. The method of claim 10, wherein the optimization method is stochastic gradient descent.

12. The method of claim 10, wherein computations of the optimization method are performed using integer computations.

13. The method of claim 1, wherein the machine learning model is a deep learning model.

14. A system for training a machine learning model comprising:
a processor; and
a memory storing instructions which, when executed by the processor, cause the system to:
receive a plurality of first data points, each data point of the first data points being represented in a floating-point representation comprising:
a sign component represented as an integer,
a floating-point exponent component represented as an integer, and
a floating-point mantissa component represented as an integer;
convert the plurality of first data points into a corresponding plurality of second data points, each of the second data points being represented in a dynamic fixed-point representation, the plurality of second data points comprising:
for each second data point, the sign component of the corresponding first data point;
for each second data point, a dynamic fixed-point mantissa component, and
one or more shared fraction components, at least two of the second data points sharing a value of a shared fraction component of the one or more shared fraction components; and
perform integer computations during training of the machine learning model using the second data points.

15. The system of claim 14, wherein the training comprises:
inputting the second data points into a machine learning model to forward propagate the second data points through the machine learning model and generate predictions for the second data points;
computing a loss based on the predictions and ground-truth labels of the second data points using integer computations; and
back-propagating the loss through the machine learning model to adjust values of parameters of the machine learning model using integer computations.

16. The system of claim 15, wherein the back-propagating comprises computing gradients, the gradients being computed using integer computations.

17. The system of claim 15, wherein the forward propagate comprises performing integer computations at a plurality of layers of the machine learning model.

18. The system of claim 15, wherein the backpropagation uses an optimization method to adjust the values of the parameters, and wherein the optimization method is stochastic gradient descent.

19. The system of claim 18, wherein computations of the optimization method are performed using integer computations.

20. The system of claim 14, wherein the machine learning model is a deep learning model.
